(19) United States
(12) Patent Application Publication
(10) Pub. No.: US 2008/0205220 A1
(43) Pub. Date: Aug. 28, 2008

(54) RECORDING APPARATUS AND RECORDING METHOD

(76) Inventor: MASAO SHIMADA, Tokyo (JP)

Correspondence Address: NEC CORPORATION OF AMERICA, 6535 N. STATE HWY 161, IRVING, TX, 75039, US

(21) Appl. No.: 12/035,226

(22) Filed: Feb. 21, 2008

(30) Foreign Application Priority Data
Feb. 23, 2007 (JP) 2007-043689

(51) Int. Cl. G11B 20/00

(52) U.S. Cl. 369/53.1

(57) ABSTRACT

A recording apparatus includes: a performance determining unit measuring recording speeds on each of unit data sizes recorded by plural kinds of access pattern to a storing device and generating performance information indicating results of the measurement; a recording request receiving unit receiving a recording request including data to be recorded on the storing device and information of size of said data; and a recording control unit selecting an access pattern corresponding to higher recording speed as well as the information of data size included in the recording request from the performance information and instructing the storing device to perform a recording process using the selected access pattern.

This application is based upon and claims the benefit of priority from Japanese patent application No. 2007-043689, filed on Feb. 23, 2007, the disclosure of which is incorporated herein in its entirety by reference.

### BACKGROUND OF THE INVENTION

1. Field of the Invention

The present invention relates to a recording apparatus for controlling input/output of a file to/from a storage medium such as a DVD (Digital Versatile Disk) or an HD (Hard Disk).

2. Description of the Related Art

For example, Japanese Patent Application Laid-Open (JP-A) No. 10-124994 discloses a technique related to recording control of data to a storing device such as a DVD or HDD. In the method described in JP-A-10-124994, a disk is divided into a plurality of areas, different recording speeds are associated with the areas and, at the time of recording data, the data is recorded in an area corresponding to a requested recording speed.

In a storing device, as the number of areas to be accessed increases, it becomes difficult for a cache memory to function well. Generally, as the data size per a recording request increases, the higher the performance of the storing device becomes. With the distance of an access area from a default position of a drive head on a recording medium, time for seeking the area increases.

However, there is a case such that, even when a control is performed to record data to a memory area corresponding to a requested recording speed as in the method disclosed in JP-A-10-124994, the performance decreases depending on complex elements such as cache memory capacity, seek time, and recording data size. Decrease in the performance of a storing device tends to cause overflow of a buffer. As a result, data may be lost.

### SUMMARY OF THE INVENTION

The present invention has been achieved in view of the above problems and an object of the invention is to provide a technique for efficiently performing recording process in consideration of balance between a request for recording data to a storing device and the specifications of the storing device.

A recording apparatus of the present invention includes: a performance determining unit measuring recording speeds on each of unit data sizes recorded by plural kinds of access pattern to a storing device and generating performance information indicating results of the measurement on each of the unit data sizes; a recording request receiving unit receiving a recording request including data to be recorded on the storing device and information of size of said data; and a recording control unit selecting an access pattern corresponding to higher recording speed as well as the information of data size included in the recording request from the performance information and instructing the storing device to perform a recording process using the selected access pattern.

A recording method according to the present invention includes the steps of: measuring recording speeds on each of unit data sizes recorded by plural kinds of access pattern to a storing device; generating performance information indicating results of the measurement on each of the unit data sizes; receiving a recording request including data to be recorded on the storing device and information of size of said data; selecting an access pattern corresponding to higher recording speed as well as the information of data size included in the recording request from the performance information; and instructing the storing device to perform a recording process using the selected access pattern.

A computer-readable medium, according to the present invention, carrying a program causing the computer functions of measuring recording speeds on each of unit data sizes recorded by plural kinds of access pattern to a storing device; generating performance information indicating results of the measurement on each of the unit data sizes; receiving a recording request including data to be recorded on the storing device and information of size of said data; selecting an access pattern corresponding to higher recording speed as well as the information of data size included in the recording request from the performance information; and instructing the storing device to perform a recording process using the selected access pattern.

According to the invention, the recording process can be performed efficiently in consideration of the balance between the specifications of the storing device and content of a recording request. Consequently, overflow of a buffer, loss of data, and the like can be prevented.

### BRIEF DESCRIPTION OF THE DRAWINGS

FIG. 1 is a block diagram showing the configuration of a recording apparatus of an embodiment of the present invention;

FIG. 2 is a diagram illustrating a cluster structure in a storing medium in the embodiment;

FIG. 3 is a diagram illustrating a cluster chain in the embodiment;

FIG. 4 is a diagram illustrating a 2-area pattern in the embodiment;

FIG. 5 is a diagram illustrating a 4-area pattern in the embodiment;

FIG. 6 is a diagram illustrating performance information in the embodiment;

FIG. 7 is a flowchart showing operations of the embodiment; and

FIG. 8 is a flowchart showing operations of another embodiment of the present invention.

### DESCRIPTION OF PREFERRED EMBODIMENTS

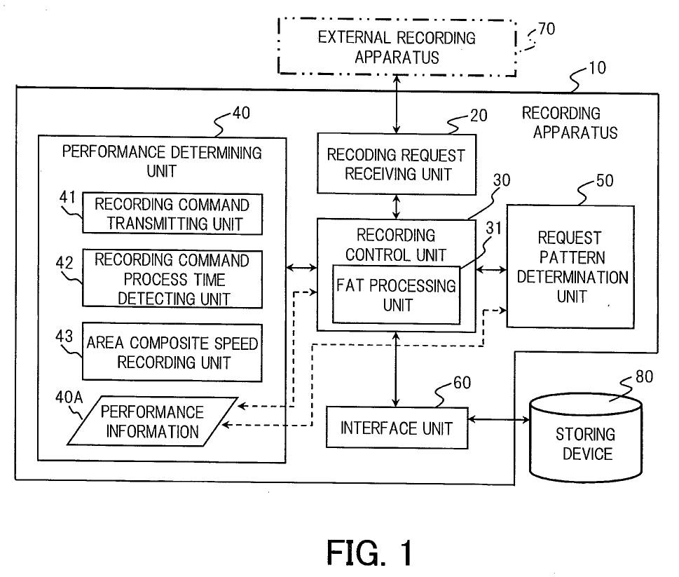

FIG. 1 shows the configuration of an embodiment of the present invention. A recording apparatus 10 records data input from an external recording apparatus 70 to a storing device 80 such as a DVD or HD in accordance with a data recording request. The recording apparatus 10 has, as its functional configuration, a recording request receiving unit 20, a recording control unit 30, a performance determining unit 40, a request pattern determination unit 50, and an interface unit 60.

The recording request receiving unit 20 has the function of receiving a recording request, recording data from the external recording apparatus 70, and transmitting them to the recording control unit 30. The recording request transmitted from the external recording apparatus 70 includes information of size of data to be recorded and recording speed. The recording request receiving unit 20 transmits information of a recording process executed as a response to the recording request from the external recording apparatus 70. The information is, for example, information indicating whether the recording process is performed according to the request from the external recording apparatus 70.

The recording control unit 30 has an FAT (File Allocation Table) processing unit 31. The recording control unit 30 determines a pattern of access to the storing device 80 in accordance with the recording request from the external recording apparatus 70. The recording control unit 30 determines an access pattern optimum for the recording request from a plurality of specified access patterns related to areas in the storing device 80 in cooperation with the request pattern determination unit 50 and the performance determining unit 40. The kinds of the access pattern will be described later. The recording control unit 30 determines an area of a cluster to which data is to be recorded in the storing device 80. The recording control unit 30 issues a command to instruct recording data to the determined area toward the storing device 80.

As shown in FIG. 1, the performance determining unit 40 includes a recording command transmitting unit 41, a recording command process time detecting unit 42, and an area composite speed recording unit 43. The recording command transmitting unit 41 issues dummy data and a recording command in accordance with kinds of the access pattern. The recording command process time detecting unit 42 and the area composite speed recording unit 43 measure a recording rate for each of access patterns by using the dummy data and the recording command and store the result of measurement as performance information 40A.

The request pattern determination unit 50 determines an access pattern corresponding to the recording rate which has been requested by the external recording apparatus 70 on the basis of the performance information 40A. The request pattern determination unit 50 notifies the recording control unit 30 of the access pattern.

The interface unit 60 transmits the recording command and the recording data to the storing device 80 in accordance with the instruction issued from the recording control unit 30.

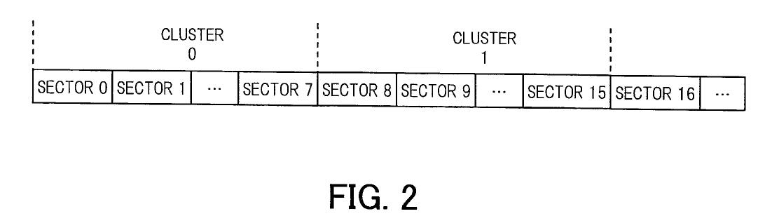

FIG. 2 schematically shows a management form of the FAT processing unit 31 related to the storing device 80. In the storing device 80, eight sectors are allocated to one cluster. Numbers for identifying clusters and sectors are assigned in ascending order to the clusters and sectors. Specifically, as shown in FIG. 2, eight sectors from “sector 0” to “sector 7” in ascending order correspond to the “cluster 0”, and the subsequent sectors from “sector 8” to “sector 15” correspond to the next “cluster 1”.

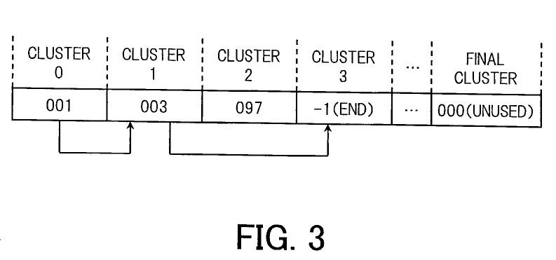

FIG. 3 shows an example of a cluster chain managed by the FAT processing unit 31. The cluster chain expresses linkage among the clusters in the storing device 80. A series of cluster chains correspond to one data file. The value “000” of the final cluster in the diagram shows that the cluster is unused. The “cluster 3” having the value “−1” is a cluster corresponding to the termination end of a cluster chain, that is, the termination end of a file. FIG. 3 shows a cluster chain in which the “cluster 0” is linked to the “cluster 1”, and the “cluster 1” is linked to the “cluster 3” at the termination end.

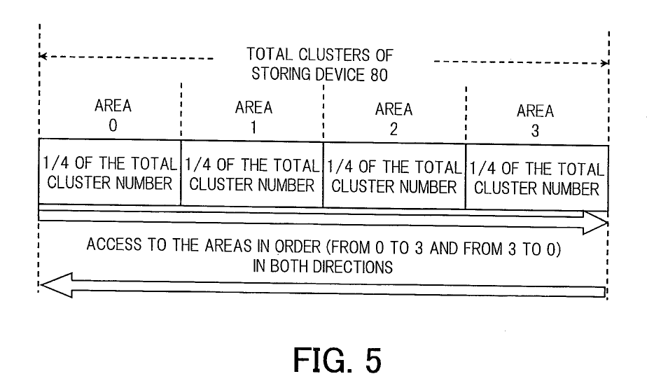

In the embodiment, two kinds of patterns for access to the storing device 80 are used. These patterns are a 2-area pattern and a 4-area pattern. The 2-area pattern means to access two areas which are obtained by dividing an area of the entire storing device 80 into two areas. The 4-area pattern means to access four areas which are obtained by dividing an area of the entire storing device 80 into four areas. FIG. 5 schematically shows the concept of the 4-area pattern.

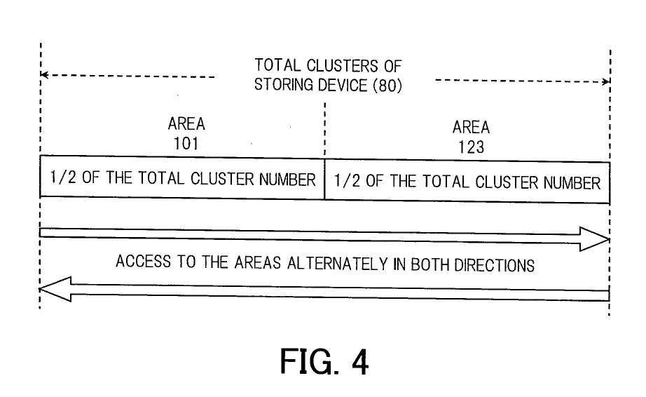

In the case of the 2-area pattern (FIG. 4), the storing device 80 is divided into a cluster group in the first half from the cluster number at the head to the last cluster number of the first half of all of the clusters in ascending order, and a cluster group in the latter half of the remaining clusters. In the example of the diagram, the cluster group in the first half corresponds to “area 101”, and the cluster group in the latter half corresponds to “area 123”. The two areas are alternately accessed.

In the case of the 4-area pattern (FIG. 5), the storing device 80 has four areas obtained by equally dividing the total number of clusters in ascending order from the cluster number at the head. In the example of the diagram, “area 0”, “area 1”, “area 2”, and “area 3” are set in order from the head. The four areas are accessed in preset order. In the example of the diagram, the bidirectional access is set. Specifically, the areas are accessed from the “area 0” to the “area 3” and, after that, accessed from the “area 3” to the “area 0” in the opposite direction.

The performance determining unit 40 measures the recording rate of the storing device 80 on the 2-area pattern and the 4-area pattern by using dummy data every unit data size. For example, in the case of measurement of the 2-area pattern, the recording command transmitting unit 41 sequentially issues dummy recording data of one megabyte to eight megabytes and dummy recording commands to the “area 101” and the “area 123” (FIG. 4). Specifically, the recording command transmitting unit 41 issues a command to record 1-megabyte data to each of the “area 101” and the “area 123” and, after that, issues a command to record 2-megabyte data to each of the areas.

In response to the request from the recording command transmitting unit 41, the recording command process time detecting unit 42 measures time required to record dummy data every unit data size such as 1-megabyte in each of the patterns. For example, in the case of measuring time with respect to 1-megabyte as the unit data size, time to record 1-megabyte data to each of the “area 101” and the “area 123” in the 2-area pattern (FIG. 4) is measured. Time to record 1-megabyte data to each of the “area 0” to “area 3” (FIG. 5) of the 4-area pattern is also measured.

The area composite speed recording unit 43 finds a recording rate of each of the unit data sizes on the patterns by using the measurement result of the recording command process time detecting unit 42. The area composite speed recording unit 43 generates the performance information 40A by using the found recording rates. The recording rate in the performance information 40A is obtained by dividing the total recorded data size by total time required for the recording for each unit data size such as 1-megabyte. For example, the recording rate of the case of recording 1-megabyte data using the 2-area pattern can be obtained by dividing the total value (2-megabytes) of the data size recorded in the “area 101” and the “area 123” by the total value of the process time on the two areas.

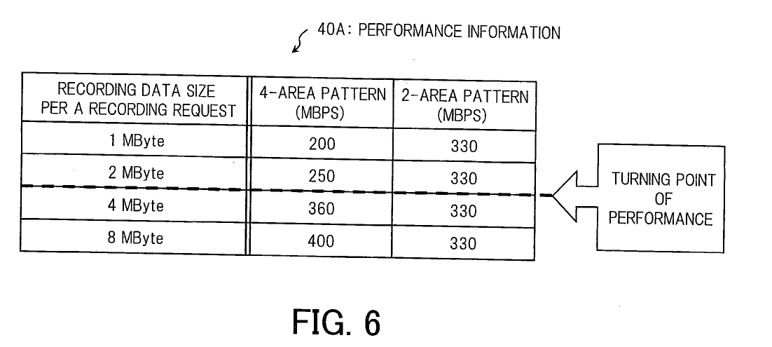

FIG. 6 shows an example of the performance information 40A. As the performance information 40A, the recording rates obtained as described above with respect to the 4-area pattern and the 2-area pattern are described in a table format. The “recording data size per a recording request” shown in FIG. 6 corresponds to a unit data size. As shown in FIG. 6, in the case of the 2-area pattern, the performance for the recording requests is constant as “330 Mbps” irrespective of the recording data size. On the other hand, in the case of the 4-area pattern, as the recording data size increases, the recording rate becomes higher. When the patterns are compared with each other, in the case where the recording data size is two megabytes or less, the performance with the 2-area pattern is higher than that with the 4-area pattern. On the contrary, in the case where the recording data size is four megabytes or larger, the performance with the 4-area pattern is higher than that with the 2-area pattern. Therefore, from the performance information 40A shown in the diagram, it can be said that the performance turning point exists between “2 Mbytes” and “4 Mbytes” of the recording data size.

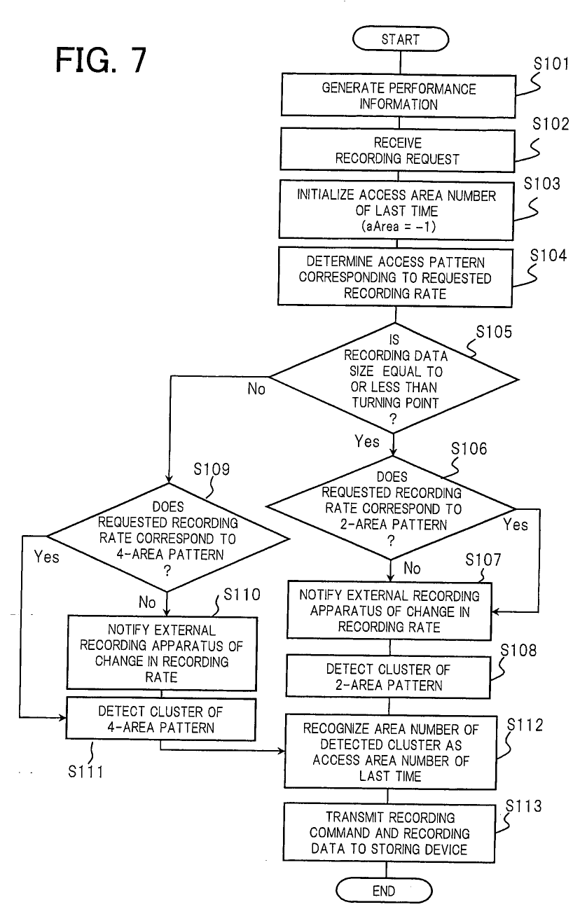

The operation of the recording apparatus 10 will be described with reference to the flowchart of FIG. 7. The performance determining unit 40 generates the performance information 40A in advance by the above-described procedure and stores it (step S101). It is assumed that the performance information 40A shown in FIG. 6 is stored as the latest one. The timing of generating the performance information 40A is, for instance, when connection of a new storing device (80) to the recording apparatus 10 is detected.

When a data recording request from the external recording apparatus 70 is received (step S102), the recording request receiving unit 20 recognizes the requested data size and recording rate. And, the recording request receiving unit 20 notifies the recording control unit 30 of the data size and the recording rate.

The recording control unit 30 initializes the area number of the storing device 80 accessed last time by setting “aArea=−1” (step S103). The recording control unit 30 instructs the request pattern determination unit 50 to determine an access pattern.

The request pattern determination unit 50 determines an access pattern corresponding to the requested recording rate with reference to the performance information 40A (step S104). For example, in the case where the requested recording rate is “400 Mbps”, it is determined from FIG. 6 that the access pattern corresponding to the requested recording rate is the 4-area pattern. In the case where the requested recording rate is “330 Mbps”, it is determined that the access pattern is the 2-area pattern. The request pattern determination unit 50 notifies the recording control unit 30 of the result of determination.

The recording control unit 30 determines whether or not the data size of the requested recording process is equal to or less than the performance turning point of the performance information 40A (step S105). In FIG. 6, in the case where the recording data size is equal to or less than the turning point, for example, “2 Mbytes”, higher performance can be realized with, as the access pattern, the 2-area pattern more than the 4-area pattern. In the case where the recording data size is equal to or higher than the turning point, for example, “8 Mbytes”, higher performance can be realized with the 4-area pattern more than the 2-area pattern.

In the case where it is determined that the data size of the requested recording process is equal to or less than the performance turning point (“Yes” in step S105), the recording control unit 30 recognizes that the 2-area pattern is to be applied as the access pattern. The recording control unit 30 also determines whether the access pattern determined by the request pattern determining unit 50 corresponding to the requested recording rate (step S104) is the 2-area pattern or not (step S106). As a result, when the requested recording rate corresponds to the 2-area pattern (“Yes” in step S106), the recording control unit 30 detects an unused cluster in the case of the 2-area pattern from the storing device 80 (step S108).

The recording control unit 30 recognizes the area number to which the detected cluster belongs as the access area number (aArea) of last time (step S112). The recording control unit 30 transmits a command for recording data by using the 2-area pattern to the storing device 80 via the interface unit 60 (step S113) and finishes the process on the recording request. As necessary, the fact that the recording process has been performed as requested is notified to the external recording apparatus 70.

On the other hand, when the requested recording rate does not correspond to the 2-area pattern, but to the 4-area pattern (“No” in step S106), the access pattern corresponding to the requested recording rate is different from the access pattern in which improvement of performance. In this case, the recording control unit 30 instructs the recording request receiving unit 20 to notify the external recording apparatus 70 of a change in the requested recording rate, that is, increase in the recording rate to place priority on improvement in the performance (step S107). The following processes are similar to the above-described procedure (steps S108, S112, and S113) on the process of recording data to the 2-area pattern, so that the description will not be repeated.

The case where the access pattern in which performance is considered is different from the access pattern corresponding to the requested recording rate is, for example, a case where the recording data size is “1 Mbyte” and the requested recording rate is “200 Mbps” corresponding to the 4-area pattern. In FIG. 6, in the case where the recording data size is “1 Mbyte”, the performance of “330 Mbps” with the 2-area pattern is higher than that of the 4-area pattern corresponding to the requested “200 Mbps”. Therefore, in this case, a message of applying the 2-area pattern and performing the recording process at a bit rate higher than the requested one is notified to the external recording apparatus 70.

When it is determined that the data size of the requested recording process is equal to or higher than the performance turning point (“Yes” in step S105), the recording control unit 30 recognizes that the 4-area pattern is to be applied as the access pattern. By a procedure according to the above-described procedure in the case of applying the 2-area pattern, data is recorded in the storing device 80 by using the 4-area pattern (steps S109, S110, S111, S112, and S113).

In the embodiment, the performance information 40A on the specifications of the storing device 80 is used and the access pattern of higher recording speed is selected according to the size of data requested to be recorded. Consequently, the recording process can be performed efficiently in consideration of the balance between the specifications of the storing device 80 and the recording request. Thus, overflow of a buffer, loss of data, and the like can be prevented. Since the control is performed to uniformly access the entire storing device 80, occurrence of a local broken sector can be prevented.

In the foregoing embodiment, when the recording rate actually applied differs from the recording request, the message of changing the recording rate is notified to the external recording apparatus 70 (steps S107 and S110). However, the process can be omitted.

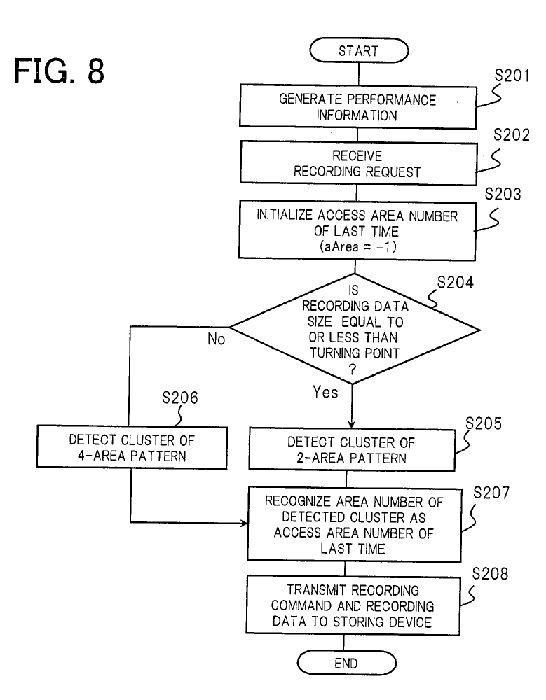

To carry out the present invention, an access pattern may be decided without determining whether the recording rate actually to be applied is according to the recording request or not. That is, the recording apparatus 10 may determine an access pattern by itself on the basis of the performance information 40A. In this case, the request pattern determining unit 50 may be omitted from the configuration of the recording apparatus 10 (FIG. 1). The embodiment will be described with reference to the flowchart of FIG. 8.

In the flowchart of FIG. 8, after generation of the performance information 40A, a recording request is received and an access area number is initialized (steps S201, S202, and S203) in a manner similar to the procedure in the foregoing embodiment (S101, S102, and S103 in FIG. 7).

The recording control unit 30 determines whether the requested recording data size is equal to or less than the turning point of the performance information 40A or not by referring to the performance information 40A (step S204). When it is determined that the requested recording data size is equal to or less than the turning point, the recording control unit 30 determines that the 2-area pattern is to be applied, and detects an unused cluster in the case of the 2-area pattern from the storing device 80 (step S205). When the requested recording data size is equal to or greater than the turning point, it is determined that the 4-area pattern is to be applied, and an unused cluster in the case of the 4-area pattern is detected from the storing device 80 (step S206).

The area number of the detected cluster is recognized as the access area number of last time (step S207), and a recording command corresponding to the access pattern is transmitted to the storing device 80 (step S208).

As described above, also by the embodiment shown in the flowchart of FIG. 8, the efficient recording process in which the specifications of the storing device 80 and content of the recording request are considered can be realized.

In the foregoing embodiments, two kinds of access patterns which are the 2-area pattern and the 4-area pattern are used. At the time of carrying out the present invention, the kinds and the number of access patterns are not limited to those in the foregoing embodiment.

The present invention can be embodied as a computer program corresponding to the operations of the foregoing embodiments or a recording medium on which the computer program is recorded.

Although the exemplary embodiments of the present invention have been described in detail, it should be understood that various changes, substitutions and alternatives can be made therein without departing from the sprit and scope of the invention as defined by the appended claims. Further, it is the inventor's intent to retain all equivalents of the claimed invention even if the claims are amended during prosecution.

What is claimed is:

1. A recording apparatus comprising:
a performance determining unit measuring recording speeds on each of unit data sizes recorded by plural kinds of access pattern to a storing device and generating performance information indicating results of the measurement on each of the unit data sizes;
a recording request receiving unit receiving a recording request including data to be recorded on the storing device and information of size of said data; and
a recording control unit selecting an access pattern corresponding to higher recording speed as well as the information of data size included in the recording request from the performance information and instructing the storing device to perform a recording process using the selected access pattern.

2. The recording apparatus of claim 1, further comprising a request pattern determining unit determining an access pattern corresponding to information of recording speed included in the recording request on the basis of the performance information,
wherein when an access pattern determined by the determining unit is different from the access pattern selected from the performance information, the recording control unit notifies a transmitter of the recording request of a message that the recording speed is going to be changed.

3. The recording apparatus of claim 1, wherein each kind of the access patterns is associated with an amount of division of a storing area in the storing device.

4. The recording apparatus of claim 3, wherein when the recording process using the access pattern selected from the performance information is instructed to the storing device, the recording control unit instructs an access to divided storing areas in preset order.

5. A recording method comprising the steps of:
measuring recording speeds on each of unit data sizes recorded by plural kinds of access pattern to a storing device;
generating performance information indicating results of the measurement on each of the unit data sizes;
receiving a recording request including data to be recorded on the storing device and information of size of said data;
selecting an access pattern corresponding to higher recording speed as well as the information of data size included in the recording request from the performance information; and
instructing the storing device to perform a recording process using the selected access pattern.

6. The recording method of claim 5, further comprising the steps of:
determining an access pattern corresponding to information of recording speed included in the recording request on the basis of the performance information; and
when the determined access pattern is different from the access pattern selected from the performance information, notifying a transmitter of the recording request of a message that the recording speed is going to be changed.

7. The recording method of claim 5, wherein each kind of the access patterns is associated with an amount of division of a storing area in the storing device.

8. The recording method of claim 7, wherein when the recording process using the access pattern selected from the performance information is instructed to the storing device, an instruction to access divided storing areas in preset order is given.

9. A computer-readable medium carrying a program causing the computer functions of:
measuring recording speeds on each of unit data sizes recorded by plural kinds of access pattern to a storing device;
generating performance information indicating results of the measurement on each of the unit data sizes;
receiving a recording request including data to be recorded on the storing device and information of size of said data;
selecting an access pattern corresponding to higher recording speed as well as the information of data size included in the recording request from the performance information; and
instructing the storing device to perform a recording process using the selected access pattern.
